(19) United States
(12) Patent Application Publication
(10) Pub. No.: US 2008/0044341 A1
(43) Pub. Date: Feb. 21, 2008

(54) Sulfurous acid mist and sulfur dioxide gas recovery system

(76) Inventors: John J. Muller, Cross Junction, VA (US); Roger A. Wittenberg, Incline Village, NV (US)

Correspondence Address: PATE PIERCE & BAIRD, 175 SOUTH MAIN STREET, SUITE 1250, SALT LAKE CITY, UT, 84111, US

(21) Appl. No.: 11/504,358

(22) Filed: Aug. 15, 2006

(51) Int. Cl. C01B 17/48; B01J 19/00

(52) U.S. Cl. 423/522; 422/160; 422/161

(57) ABSTRACT

A system is disclosed for retrieving a mist of sulfurous acid and creating sulfurous acid from residual sulfur dioxide gas originating from an exhaust of a sulfurous acid generator. In one embodiment, such a system includes a sulfurous acid generator to output sulfurous acid, in a primary stream, and exhaust comprising a mist of sulfurous acid and sulfur dioxide gas. A recovery system is connected to the sulfurous acid generator to receive the exhaust and substantially remove the mist and the sulfur dioxide gas. The recovery system is further structured to pass the exhaust to apertures therein sized to separate the mist from the exhaust, wet itself with the liquid of the mist, and capture the sulfur dioxide gas with the liquid to substantially remove them both from the exhaust.

### BACKGROUND

1. The Field of the Invention

This invention relates to apparatus and methods for generating sulfurous acid, and more particularly to apparatus and methods for retrieving a mist of sulfurous acid and creating sulfurous acid from residual sulfur dioxide gas originating from an exhaust of a sulfurous acid generator.

2. Background

Alkaline soils typically result from the accumulation of free salts in land to such an extent that it leads to degradation of the soil and the ability to grow vegetation thereon. Highly alkaline soils may be the result of natural processes such as high salt levels in soil, changes in landscape that allow salt to become mobile (such as by natural changes in the water table), and climate changes that promote accumulation. Human practices, however, have also drastically increased soil alkalinity in many areas. For example, human practices such as irrigation, changes to the natural water table by darns or other man-made structures, changes in the natural balance of the water cycle, and excessive recharging of groundwater and accumulation through concentration, have caused extensive increases in soil alkalinity in many areas, including much formerly productive farmland.

Because virtually all water other than natural precipitation contains dissolved salts, alkalinity increases from irrigation over time. That is, after irrigation water is absorbed by vegetation, evaporates, or drains to other areas, the dissolved salt is deposited and accumulates in the soil. The salt, in turn, inhibits vegetation's ability to absorb moisture from the soil and may damage plants chemically. In addition to detrimental effects on vegetation and yield, highly alkaline soils also damage infrastructure (e.g., roads, bricks, pipes, cables, etc.), reduce water quality, and ultimately lead to soil erosion.

To counteract or reverse the negative effects of excessive alkalinity, sulfurous acid may be added to irrigation water to reduce its alkalinity. In particular, sulfurous acid may be used to control water pH and address the adverse effects of salts or other substances such as bicarbonates, sodium, and chlorides in irrigation water. Furthermore, sulfurous acid, unlike sulfuric acid, is safer to handle and may be generated economically.

Applications for sulfurous acid are plentiful, including, among others, agriculture, turf and lawn irrigation, wastewater treatment, and coal-bed-methane water reclamation. Sulfurous acid may also be used to control algae without threatening aquatic growth or plant life, remove excess chlorine from wastewater, descale calcium carbonate deposits or mollusks (e.g., zebra mussels, barnacles, etc.) in pipes or other water conduits or tanks, treat aqueous mixtures such as mine slurries, process sugar, and the like. In other cases, sulfurous acid may be applied as a nutrient for vegetation or be used as a fungicide.

To produce sulfurous acid, different entities currently market or fabricate various sulfurous acid generators. These generators typically produce sulfurous acid by burning elemental sulfur to create sulfur dioxide gas. This gas is then combined with water to produce sulfurous acid. Nevertheless, all of these sulfurous acid generators also produce chemically formed mist particles of tiny size as a byproduct. When released, this mist creates a large and highly visible plume.

Moreover, this mist is difficult if not impossible to eliminate using currently available scrubbers that employ liquid spray and scrubber packing. Even generators that employ a second vapor recovery aspirator after the mixing chamber do not eliminate the majority of the mist, but rather just move the mist down the water discharge tube. The mist is still highly visible and detectable upon discharge.

Due to the mist's sub-micron size and its chemically formed nature, the mist moves with the surrounding gases and is not readily placed in contact with or absorbed by water. The majority of particles smaller than 250 micron diameter are released into the atmosphere. Compounding this problem is light scattering, a phenomenon at a maximum with submicron particles. Thus, a small amount of mist creates a large visible plume.

There is some debate whether sulfur dioxide gas forms sulfurous acid or simply stays in water as dissolved ions. Sulfur dioxide gas, whether entrained or dissolved in the mist is free to separate from the mist upon evaporation of the water or upon release of mist to the atmosphere. Sulfur dioxide is also easily detected by smell. Thus, the mist may be a nuisance environmentally, aesthetically, and commercially. For example, depending on local zoning and permitting conditions, the odors, visible plumes, emission standards, or the like may restrict use or installation of sulfurous acid generators employing sulfur burners.

In view of the foregoing, what are needed are apparatus and methods for recovering most if not all of the mist produced by sulfurous acid generators. Further needed are apparatus and methods for removing residual sulfur dioxide gas not captured in the sulfurous acid generation process. Ideally, such a system and method would allow the sulfurous acid generator to maintain maximum sulfur burn rates. Furthermore, such an apparatus and method would ideally remove the mist and any residual sulfur dioxide from the exhaust effectively in a single pass, even in a single step. Such an apparatus and method may be employed in a larger overall system for safely generating sulfurous acid on demand.

### BRIEF SUMMARY OF THE EMBODIMENTS

Consistent with the foregoing, and in accordance with the invention as embodied and broadly described herein, a system is disclosed for retrieving a mist of sulfurous acid and creating sulfurous acid from residual sulfur dioxide gas originating from an exhaust of a sulfurous acid generator. Such a system is disclosed in one embodiment in accordance with the invention to include a sulfurous acid generator to output sulfurous acid, in a primary stream, and an exhaust comprising a mist of sulfurous acid and sulfur dioxide gas.

A recovery system is connected to the sulfurous acid generator to receive the exhaust and substantially remove the mist and the sulfur dioxide gas. The recovery system is further structured to pass the exhaust to apertures therein sized to separate the mist from the exhaust, wet itself with the liquid of the mist, and capture the sulfur dioxide gas with the liquid to substantially remove them both from the exhaust. A path from the recovery system conducts a recovered stream of sulfurous acid generated by the recovery system.

In certain embodiments, the recovery system includes a filter employing one or more of a fiber bed, a filament bundle, a screen, a sieve, a mesh, a paper, a natural textile fabric, a synthetic polymer fabric, a metal fabric, a woven fabric, a non-woven fabric, a media filter, or combinations thereof. The filter may, in certain embodiments, include filter media arranged in a plurality of layers. In selected embodiments, the apertures of the recovery system are sized to separate (capture) mist particles having a size of less than 30 microns from a gas flow. The mist may typically be separated from the exhaust by way of inertial impaction, i nterception, Brownian diffusion, or the like.

In certain embodiments, the path from the recovery system directs the recovered stream of sulfurous acid into the primary stream of sulfurous acid. Furthermore, an outlet may be coupled to the recovery system and a motive source may draw or push the exhaust through the recovery system. A suitable motive source may include, for example, a fan, a venturi, an aspirator, an eductor, or the like. In other embodiments, the sulfurous acid generator may include a sulfur dioxide gas scrubber prior to the recovery system. The recovery system may be integrated with the sulfurous acid generator or be a “stand alone” device that may be used to retrofit legacy sulfurous acid generator systems.

In another embodiment in accordance with the invention, a method is disclosed to retrieve a mist of sulfurous acid and create sulfurous acid from residual sulfur dioxide gas originating from an exhaust of a sulfurous acid generator. Such a method may include generating sulfurous acid, in a primary stream, and discharging an exhaust comprising a mist of sulfurous acid and sulfur dioxide gas. The method may further include one or more of receiving the exhaust and substantially removing the mist and the residual sulfur dioxide gas. The method then may include one or more of passing the exhaust through apertures sized to separate the mist from the exhaust, wetting the apertures with the liquid of the mist, and capturing the sulfur dioxide gas by placing it in intimate contact with the liquid to substantially remove them both from the exhaust. A process of these steps may be used to generate a recovered stream of sulfurous acid.

In certain embodiments, the method may include passing the exhaust through a mass transfer device such as a filter employing a fiber bed, a filament bundle, a screen, a sieve, a mesh, a paper, a natural textile fabric, a synthetic polymer fabric, a metal fabric, a woven fabric, a non-woven fabric, a media filter, or combinations thereof. Similarly, the exhaust may pass through apertures sized to separate mist particles having a size of less than 30 microns from the exhaust. These mist particles may be separated from the gas of the exhaust by contact resulting from inertial impaction, interception, Brownian diffusion, or a combination thereof. Once the sulfur dioxide gas and mist are removed from the exhaust, the recovered stream of sulfurous acid may be directed into the primary stream of sulfurous acid.

In another embodiment, an alternative system is disclosed to retrieve a mist of sulfurous acid and create sulfurous acid from residual sulfur dioxide originating from an exhaust of a sulfurous acid generator. The system typically includes a sulfurous acid generator comprising a source of sulfur dioxide and a source of water connected to feed into a mixer. The mixer outputs sulfurous acid, in a primary stream, and exhaust comprising a mist of sulfurous acid, water vapor, nitrogen gas, sulfur dioxide gas, and possibly some unreacted oxygen.

A recovery system is connected to the sulfurous acid generator to receive the exhaust and substantially remove the mist and the sulfur dioxide gas. In one embodiment, a recovery system is further structured to pass the exhaust through apertures therein sized to separate the mist from the gases, wet itself with the liquid of the mist, and capture the sulfur dioxide gas with the liquid to substantially remove them both from the exhaust. A path from the recovery system conducts a recovered stream of sulfurous acid generated by the recovery system.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments in accordance with the invention and are, therefore, not to be considered limiting of its scope, the invention will be described with additional specificity and detail through use of the accompanying drawings in which:

FIG. 1 is a perspective view of major components of one embodiment of a sulfurous acid generator in accordance with the invention;

FIG. 2 is a cutaway perspective view of major components of one embodiment of a sulfurous acid generator in accordance with the invention;

FIG. 3 is a schematic representation of one embodiment of a sulfurous acid generator in accordance with the invention;

FIG. 4 is a schematic representation of another embodiment of a sulfurous acid generator in accordance with the invention;

FIG. 5A is a schematic representation of another embodiment of a sulfurous acid generator in accordance with the invention;

FIG. 5B is a schematic representation of another embodiment of a sulfurous acid generator in accordance with the invention;

FIG. 6 is a schematic representation of another embodiment of a sulfurous acid generator in accordance with the invention;

FIG. 7 is a cutaway perspective view of one embodiment of an improved sulfur burner in accordance with the invention;

FIG. 8 is a schematic view of one embodiment of an air inlet in accordance with the invention;

FIG. 9 is a cutaway perspective view of one embodiment of a cyclone mixer and chamber in accordance with the invention;

FIG. 10 is a front elevation view of the cyclone mixer and chamber illustrated in FIG. 9;

FIG. 11 is a rear elevation view of one embodiment of a cyclone mixer as it appears from inside the chamber;

FIG. 12 is a side elevation view of one embodiment of a safety valve in accordance with the invention;

FIG. 13 is a side elevation view of another embodiment of a safety valve in accordance with the invention;

FIG. 14 is a side elevation view of one embodiment of an improved eductor for use with apparatus and methods in accordance with the invention;

FIG. 15 is a schematic representation of another embodiment of a sulfurous acid generator in accordance with the invention; and

FIG. 16 is a schematic representation of one embodiment of a sulfurous acid generator in accordance with the invention having various components mounted at different levels.

### DETAILED DESCRIPTION OF THE EMBODIMENTS

It will be readily understood that the components of the present invention, as generally described and illustrated in the Figures herein, could be arranged and designed in a wide variety of different configurations. Thus, the following more detailed description of the embodiments of apparatus and methods in accordance with the present invention, as represented in the Figures, is not intended to limit the scope of the invention, as claimed, but is merely representative of certain examples of selected embodiments contemplated in accordance with the invention. The presently described embodiments will be best understood by reference to the drawings, wherein like parts are designated by like numerals throughout.

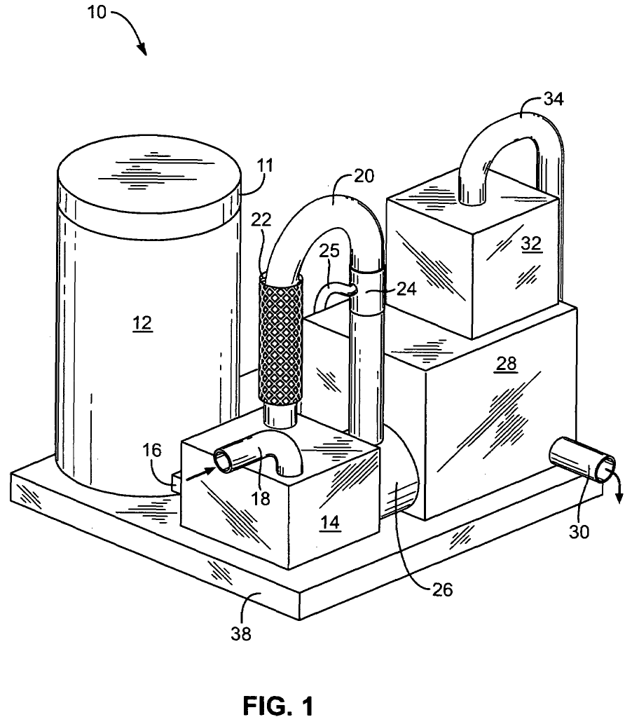

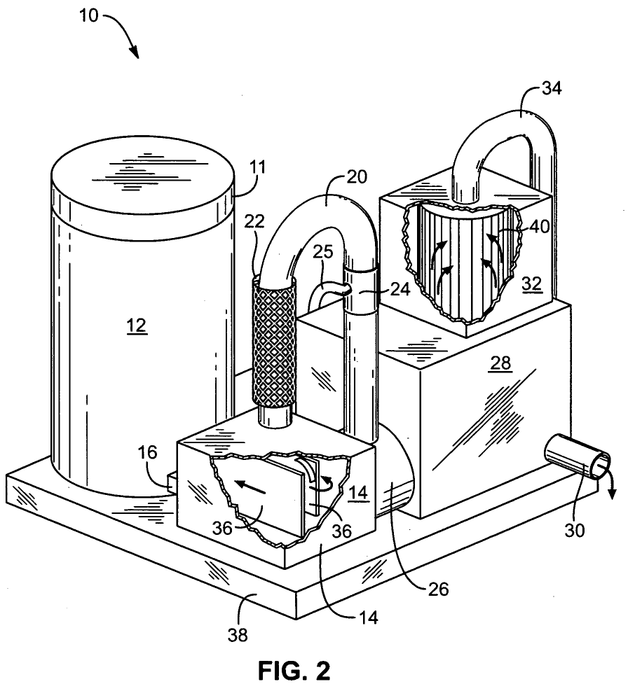

Referring to FIGS. 1 and 2, in general, one embodiment of a sulfurous acid generator 10 in accordance with the invention may include a hopper 12 or storage tank 12, a sulfur burner 14, an induction channel 20, an eductor 24, a chamber 28, and an outlet 30 for outputting sulfurous acid. In addition, the sulfurous acid generator 10 may produce an exhaust that may be passed through a recovery system 32 in accordance with the invention, after which the exhaust may flow through an exhaust outlet 34. As will be explained in more detail hereafter, in certain embodiments, the exhaust may be drawn or pushed through the recovery system 32 and outlet 34 by way of a motive device, such as a fan, blower, compressor, eductor, aspirator, exhauster, or the like.

The sulfurous acid generator 10 illustrated in FIGS. 1 and 2 provides an overview of the major components of one embodiment of a sulfurous acid generator 10 in accordance with the invention. Thus, various details (e.g., valves, wiring, etc.) have been omitted to simplify the current description or because these details are unnecessary to understand the specific systems, apparatus, and methods illustrated. Furthermore, one of ordinary skill in the art will recognize that the various components of the sulfurous acid generator 10 may take on various shapes and arrangements. For example, some or all of the components 12, 14, 20, 24, 28, 32 could be provided on a single platform, multiple platforms, inside a single or multiple enclosures, or the like. Thus, the generator 10 disclosed herein is presented only by way of example and is not limited to the illustrated shape, arrangement, or appearance.

In general, a hopper 12 or storage tank 12 may store a supply of sulfur, such as sulfur pellets, powder, or flakes. The sulfur may be supplied to a sulfur burner 14 through a feed channel 16, typically mounted at or near the base of the hopper 12 and burner 14, providing a path for sulfur to pass between the hopper 12 and the burner 14. During combustion in the burner 14, the sulfur in the feed channel 16 may melt back into the hopper 12 to “self feed.” In certain embodiments, the weight of the sulfur stored in the hopper 12 also urges sulfur through the feed channel 16 to provide a constant supply of sulfur to the burner 14.

In certain embodiments, a burner 14 may comprise multiple ports to interface with multiple feed channels 16 or to interface with other burners 14. By allowing sulfur to enter a burner 14 through multiple feed channels 16, lower profile hoppers 12 may be used which are more easily loaded with sulfur. Furthermore, these burner ports may also allow multiple burners 14 to be “daisy chained” together to provide additional burning capacity, as needed. In certain embodiments, a heat shield, such as a fire-brick heat shield, may be installed between the burner 14 and the hopper 12 as an insulator, radiation shield, or thermal buffer to avoid an excessive melting rate of the sulfur in the burner 14.

In certain embodiments, the sulfur feed rate through the feed channel 16 may be adjusted to prevent or reduce overfilling of the burner 14. This may be accomplished, in certain embodiments, by providing a regulator to partially block the channel 16 from inside the hopper 12. This regulator, which may be constructed of fire brick or a similar heat-resistant material, may be used to restrict the flow of heat or mass (sulfur) into the molten pool of sulfur in the feed channel 16 between the burner 14 and the hopper 12.

The sulfur may be fed into an interior chamber of the burner 14 where it is ignited and burned. An air inlet 18, coupled to the burner 14, is used to supply air to the combustion reaction, wherein oxygen combines with the sulfur to produce sulfur dioxide and heat. As will be explained in more detail hereafter, in certain embodiments, the burner 14 may include a series of baffles 36, to circulate the oxygen over the burning sulfur. This may provide a sulfur burner 14 with increased dwell times at combustion temperatures to increase burn rate capacities without increasing the overall size or height of the burner 14. The baffles 36 may also enable significantly larger sulfur consumption rates without significantly increasing the air flow intake through the inlet 18. This increase in efficiency is believed to be the result of the additional contact time between the oxygen and the burning sulfur as it circulates around the baffles 36.

Nevertheless, a sulfurous acid generator 10 in accordance with the invention may also employ conventional circular burners 14. These burners 14 are typically designed to swirl oxygen in a partial, direct, or circular path around the burner 14 before exiting.

Once sulfur dioxide gas is generated, an eductor 24 may draw the sulfur dioxide out of the burner 14 through an induction channel 20. Because the sulfur dioxide and other gases entering the induction channel 20 are typically very hot, a heat guard 22 may be used to cover all or part of the induction channel 20. A channel 25 supplies water to the eductor 24, where it is directed downward through the induction channel 20. For the purposes of this description, the term “water” or “water supply” may include pure water as well as aqueous mixtures (e.g., irrigation water). The drag created by the downward motion of the water creates a reduced pressure (e.g., vacuum effect) above the eductor 24, thereby drawing sulfur dioxide and other gases with the water through the induction channel 20.

Ideally, the water also mixes with the sulfur dioxide as it flows down the channel 20, generating sulfurous acid. In other embodiments, the water maybe supplied under increased pressure and sprayed downward, finely dispersed, through the induction channel 20 at high velocity to create the suction. This technique may also be more effective to mix the sulfur dioxide with the water.

After passing through the eductor 24, sulfurous acid as well as residual sulfur dioxide gas and other gases may flow to a cyclone mixer 26 connected to a chamber 28. As will be explained in more detail hereafter, the cyclone mixer 26 may circulate and create turbulence in the sulfurous acid and residual sulfur dioxide gas in an attempt to bring the remaining sulfur dioxide gas into solution. This solution may then pass from the cyclone mixer 26 to a chamber 28, which may act to separate liquid from gases and vapors that did not enter into the aqueous mixture.

The solution may be retained in the chamber 28 until it reaches a sufficient level to flow through an outlet 30, where it may be drawn out by gravity. An outlet 30 may incorporate a p-trap or other suitable trap to prevent exhaust gases from exiting through the outlet 30 with the sulfurous acid. A chamber 28 may have any suitable shape or volume and may be constructed of any material having the requisite strength and resistance to heat and sulfurous acid. Suitable materials may include, for example, stainless steel, plastic, PVC, or the like.

In addition to generating a primary stream of liquid sulfurous acid for output at the outlet 30, the generator 10 may produce an exhaust containing, among other gases, a mist of sulfurous acid, water vapor, water, nitrogen gas, and sulfur dioxide gas and traces of other gases, such as oxygen. This exhaust may be routed through the chamber 28 to a recovery system 32. The recovery system 32 may receive the exhaust, substantially remove the mist, and capture the sulfur dioxide gas (i.e., bring the sulfur dioxide gas into mixture or solution to generate sulfurous acid). As explained in more detail hereafter, the recovery system 32 may also be used to provide a pressure differential. This may prevent or at least reduce the likelihood that water vapor in the exhaust will condense and thereby create a visible plume of mist as the exhaust enters the atmosphere.

In general, the recovery system 32 may be structured to pass the exhaust through apertures in the recovery system 32 sized to separate the mist from the gases. In certain embodiments, mechanically created mist particles (i.e., mist created by agitation, spraying, etc.) may have sizes in the range of thirty microns to one thousand microns. However, mists generated by chemical reactions or from saturated vapor (i.e., condensation) may be much smaller, in the range of 0.1 to 30 microns. The generation of sulfurous acid generally produces very fine mists, possibly the result of the chemical reaction. Thus, in certain embodiments, the apertures may be sized to remove mist particles having a size of less than 30 microns, in addition to the larger mist particles mechanically created.

In the process of removing the mist particles, the apertures of the recovery system 32 may be wetted with the liquid of the mist. This liquid may be used to used to capture or otherwise assimilate the sulfur dioxide gas with the liquid, such as by creating contact between the sulfur dioxide gas and the liquid, to substantially remove the sulfur dioxide from the exhaust. Removal efficiency may be improved by increasing the dwell time of the sulfur dioxide gas over the wetted apertures or by increasing the surface area of the wetted apertures in contact with the sulfur dioxide gas.

By collecting the mist into liquid form, and by removing residual sulfur dioxide gas from the exhaust with the liquid, the recovery system 32 may provide a secondary source of sulfurous acid. In certain embodiments, this sulfurous acid may be simply directed into the primary supply of sulfurous acid in the chamber 28. Thus, in addition to removing mist and sulfur dioxide gas from the exhaust, the recovery system 32 may also function as a secondary sulfurous acid generator.

As mentioned, the recovery system 32 may also be used to provide a pressure differential between the exhaust in the chamber 28 and the exhaust exiting the recovery system 32 through an exhaust outlet 30, which may eventually enter the atmosphere. The pressure differential (i. e., the ratio between the atmospheric pressure and the pressure inside the chamber 28), may be a function of the pressure inside the chamber 28, which may depend on factors such as the strength (e.g., pressure rise) of the eductor 24 and the exhaust flow rate through the chamber 28, the atmospheric pressure, and the recovery system's aperture size, density, number, and the like.

Properly setting or adjusting the recovery system pressure differential may prevent or reduce the likelihood that water vapor will condense into a visible plume upon exiting the recovery system 32. Since the recovery system 32 vents or exhausts to atmospheric pressure, the pressure inside it is higher due to fluid drag of passage of fluids through the filter of the recovery system 32. Thus, this pressure differential may tend to promote rapid evaporation and a reduction of the relative humidity in the flow exiting into the environment.

For example, because of the abundance of water in the chamber 28, the relative humidity inside the chamber 28, may be close to one hundred percent. Absent a change in pressure, this water vapor may condense when cooled, which may occur upon exiting the recovery system into a cooler atmosphere. This is likely to create a visible plume until the moist exhaust stream can fully evaporate any condensate.

Nevertheless, by properly adjusting the recovery system pressure differential (e.g., adjusting the number of apertures, aperture size, aperture density, etc.), the cooler temperatures may also be accompanied by an offsetting pressure drop. This pressure drop will promote evaporation and drive the water vapor away from condensing and creating a visible plume. In certain embodiments, the recovery system pressure differential may be adjusted such that the relative humidity (which depends on both temperature and pressure) inside the chamber 28 will produce a roughly equivalent or lower relative humidity after exiting the recovery system 32. This will prevent or reduce the likelihood that water vapor in the exhaust will condense.

Although the previous example is provided for atmospheric temperatures that are cooler than temperatures inside the chamber 28, in many cases the temperature of gases inside the chamber 28 may actually be cooler than the outside environment. For example, the temperature of water or other aqueous mixtures passing through the chamber 28 may be significantly cooler than the outside environment and may actually cool the gases passing through the chamber 28 such that they are cooler than the outside environment. In such cases, exhaust flowing through the recovery system 32 is unlikely to condense upon exit.

In certain embodiments, the recovery system apertures may be provided by a filter 40. Such a filter 40 may employ, for example, a fiber bed, a filament bundle, a screen, a sieve, a mesh, a paper, a natural textile fabric, a synthetic polymer fabric, a metal fabric, a woven fabric, a non-woven fabric, a media filter, or combinations thereof, to remove the mist from the exhaust, remove sulfur dioxide from the exhaust, and provide a pressure differential. The above-mentioned filter media may, in certain embodiments, be arranged in a plurality of layers to improve its filtering capability.

For example, a filter 40 comprising a densely packed fiber bed may be employed in a recovery system 32 to remove a mist of sulfurous acid and create sulfurous acid from residual sulfur dioxide gas. For example, various filters under the FLEXIFIBER brand name, produced by Koch-Otto York, have been found suitable to separate the mist from the exhaust, remove sulfur dioxide from the exhaust, and provide a pressure differential to prevent water condensation. These filters employ beds of special fibers densely packed between two screens. The mist-laden exhaust enters one side of the fiber bed and filtered gas and liquid streams exit the other side of the fiber bed.

A filter 40, such as a fiber bed filter, may remove mist from the exhaust using three basic mechanisms: inertial impaction, interception, and Brownian diffusion. With reference to inertial impaction, as the exhaust streams around a fiber, larger mist particles (e.g., above 1 micron) may deviate from the tortuous bending exhaust stream due to their larger inertia to directly impact and be captured by the fiber. With reference to interception, some smaller mist particles (e.g., smaller than one micron) may be captured by surface tension and contact without inertial impaction if the streamline is close enough to the fiber. That is, even if a mist particle is traveling around a fiber, the particle may still touch against the fiber or liquid on the fiber or other filter media. This may cause the surface tension of the mist particle to join that of the surface liquid on the fiber. Finally, very small particles (e.g., less than 1 micron) may exhibit considerable Brownian movement and thereby diffuse from the exhaust to contact the surface of the fiber.

In certain embodiments, a motive device, such as a fan, blower, compressor, aspirator, venturi, eductor, siphon, exhauster, or the like, may be coupled to the exhaust outlet 34 and be used to draw or push the exhaust through the recovery system 32. This may aid the eductor 24 in creating a liquid sulfurous acid and exhaust flow through the sulfurous acid generator 10.

In selected embodiments, an odor wick may be installed at some point, typically after the recovery system 32, such as in the exhaust outlet 34 or after the motive device. An odor wick may emit a fragrance, add a reactant, or both to improve the scent of the exhaust in the event some residual sulfur compounds are still present in the exhaust output to atmosphere.

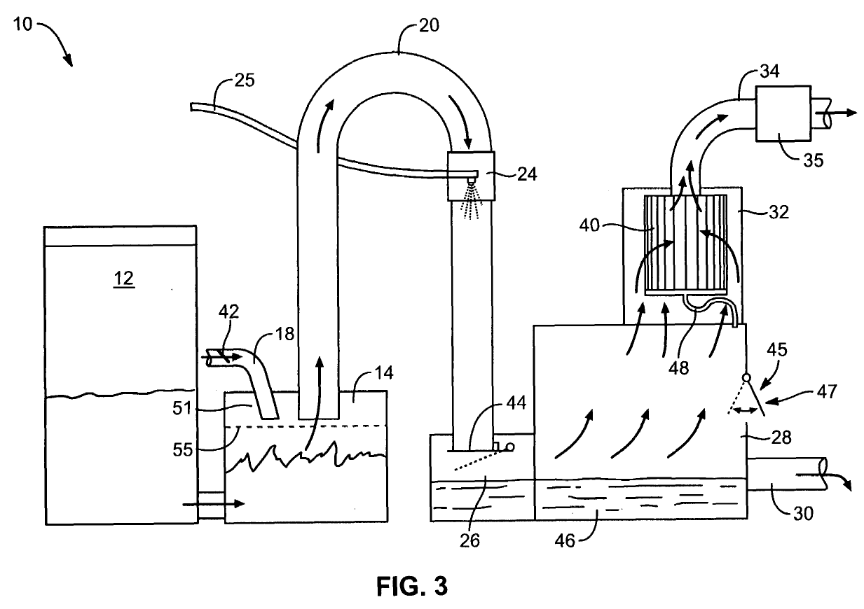

Referring to FIG. 3, as previously mentioned, a sulfurous acid generator 10 in accordance with the invention may include a hopper 12 or storage tank 12, a sulfur burner 14, an induction channel 20, an eductor 24, a chamber 28, a recovery system 32, an outlet 30 for outputting sulfurous acid, and an outlet 34 for outputting exhaust. The sulfurous acid generator 10 may also include various safety components to ensure that products of combustion, such as compounds of sulfur or chemically generated mists, are not output to the environment, particularly when the sulfurous acid generator 10 is being shut down or the water flow through the eductor 24 is interrupted. Such a condition may occur when sulfur continues to burn or smolder in the burner 14 even after shutdown or interruption of the water supply.

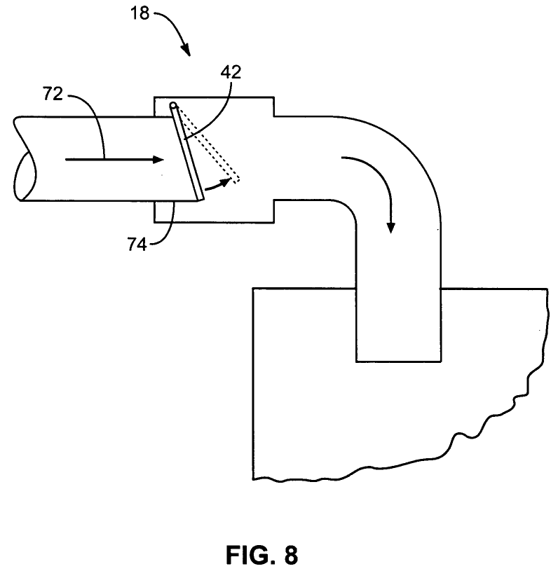

For example, in certain embodiments, the sulfurous acid generator 10 may include a backflow inhibitor 42 in the air inlet 18 and a safety valve 44 located at or near the bottom of the induction channel 20. Both the backflow inhibitor 42 and the safety valve 44 may be used to prevent or resist the release of products of combustion from the sulfur burner 14 and the induction channel 20 when shutting down the sulfurous acid generator 10 or in the event of an interruption of water flow through the eductor 24. Various embodiments of the backflow inhibitor 42 and the safety valve 44 are discussed in association with FIGS. 8, 12, and 13.

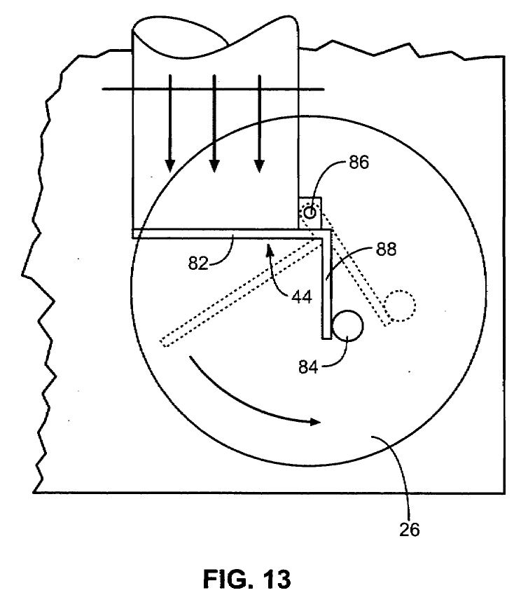

As illustrated, the eductor 24 may release or spray water down the induction channel 20. This creates suction above the eductor 24, thereby drawing sulfur dioxide gas with the water down the induction channel 20. Ideally, this also mixes the water with the sulfur dioxide to produce sulfurous acid. The force, momentum, or pressure of the sulfurous acid will open the safety valve 44 as the flow travels downward through the induction channel 20. As will described with additional specificity with respect to FIGS. 12 and 13, the safety valve 44 may be biased to open only for water or sulfurous acid traveling down the induction channel 120, but remain shut when only gases are present or urged through the channel 20, or when gases attempt to flow backward through the induction channel 20.

Similarly, the backflow inhibitor 42 may prevent exhaust or other products of combustion from flowing backward through the air inlet 18 to the environment. Thus, both the safety valve 44 and the backflow inhibitor 42 may effectively isolate the burner 14 and the induction channel 20 from the environment when shutting down the sulfurous acid generator 10 or interrupting the water supply to the eductor 24. The safety valve 44 and the backflow inhibitor 42 may also enable rapid, abrupt shutdown of the burner 14 without the prolonged smoldering typical of many sulfurous acid generators 10.

Once it passes through the induction channel 20, the sulfurous acid and remaining water and sulfur dioxide gas are mixed and circulated upon entering a cyclone mixer 26. The sulfurous acid 46 and exhaust, including residual sulfur dioxide gas and liquid mist, then pass into the chamber 28. The sulfurous acid is then free to flow from an outlet 30.

In certain embodiments, the exhaust flows directly from the chamber 28 to a recovery system 32. The exhaust may flow through apertures in the recovery system 32, such as through a filter 40, to remove the mist from the exhaust stream, remove residual sulfur dioxide gas from the exhaust, and provide a pressure differential. Sulfurous acid generated by the recovery system 32 may flow down through the inside of the filter 40 to a drain 48. The drain 48 may provide a secondary supply of sulfurous acid, a useable product, which may be directed into the primary supply 46.

In certain embodiments, the drain 48 may be shaped like a “p-trap” to prevent gases inside the chamber 28 from traveling up through the drain 48 and out the exhaust outlet 34. The outlet of the p-trap may, in certain embodiments, extend into the sulfurous acid supply 46to keep gases from entering the trap. Alternatively, the drain 48 may simply connect to a tube or channel leading from the filer 40 into the sulfurous acid supply 46 without using a p-trap. To draw or push exhaust through the recovery system 32, a motive device 35, such as a fan, blower, compressor, eductor, aspirator, venturi, siphon, or the like, may be coupled to the outlet 35. Alternatively, it is contemplated that the motive device 35 may be connected at some point before the recovery system 32 to push the exhaust through the recovery system 32.

In selected embodiments, a relief valve 45 may be provided to allow air to flow through the recovery system 32 in the event the safety valve 44 is closed (possibly due to an interruption in the water flow to the eductor 24), while the motive device 35 is still operating. The relief valve 45 may prevent the safety valve 44 from opening due to suction inside the chamber 28, created by the motive device 35, by allowing air to enter the chamber 28. This may ensure that products of combustion are substantially sealed within the burner 14 and induction channel 20 by ensuring that the motive device 35 does not open the safety valve 44.

Similarly, a discharge valve 47 may be provided to allow discharge of exhaust to the environment in the event the safety valve 44 is open but the motive device 35 is not operating. For example, in the event of a pressure buildup within the chamber 28 due to a failure of the motive device 35, the discharge valve 47 may open to allow the exhaust to discharge directly into the environment.

In certain embodiments, both the relief valve 45 and the discharge valve 47 may be provided by a single two-way flapper valve 45, 47, as illustrated in FIG. 3, or an adjustable opening. The flapper valve 45, 47 may open outward (relative to the chamber 28) in response to a pressure buildup within the chamber 28 and inward in response to an increased vacuum within the chamber 28. Nevertheless, in other embodiments, the relief valve 45 and the discharge valve 47 may be embodied as separate valves 45, 47 or other restrictive elements.

In certain embodiments, to prevent overflowing or overfilling of the sulfur burner 14, a low end 51 of the air inlet 18 may extend downward into the sulfur burner 14 to a limit level 55 selected to stop flow of gases through the air inlet 18 when sulfur exceeds the limit level 55. This provides a safety mechanism in the event that, during operation, the level of molten sulfur continues to rise too high, or if sulfur combusts in the burner 14 after the sulfurous acid generator 10 has been shut down or the water supply to the eductor 24 has been interrupted. As the burner fills with sulfur to the limit level 55, the air supply is cut off as the sulfur seals off the end 51 of the inlet 18, thereby extinguishing or slowing the combustion reaction within the burner 14. This design is also highly reliable in that it requires no moving parts.

Some or all of the safety components, including the backflow inhibitor 42, the air inlet 18 for preventing sulfur overflow, the safety valve 44, the recovery system 32 for removing mist and residual sulfur dioxide gas, the motive device 35, the relief valve 45, and the discharge valve 47, may be included in a fail-safe, on-demand, sulfurous acid generator 10 in accordance with the invention. In certain embodiments, some or all of the components 18, 24, 32, 35, 40, 42, 44, 45, 47, 54, 56, 60 may be provided as original equipment in a sulfurous acid generator 10. In other embodiments, some or all of the components 18, 24, 32, 35, 40, 42, 44, 45, 47, 54, 56, 60 may be provided in a “retrofit kit” to upgrade or increase the safety of existing sulfurous acid generators 10. Such a retrofit kit may, in certain embodiments, require modification of an existing generator 10 or may include adapters to interface with different types, sizes, and configurations, of generators 10.

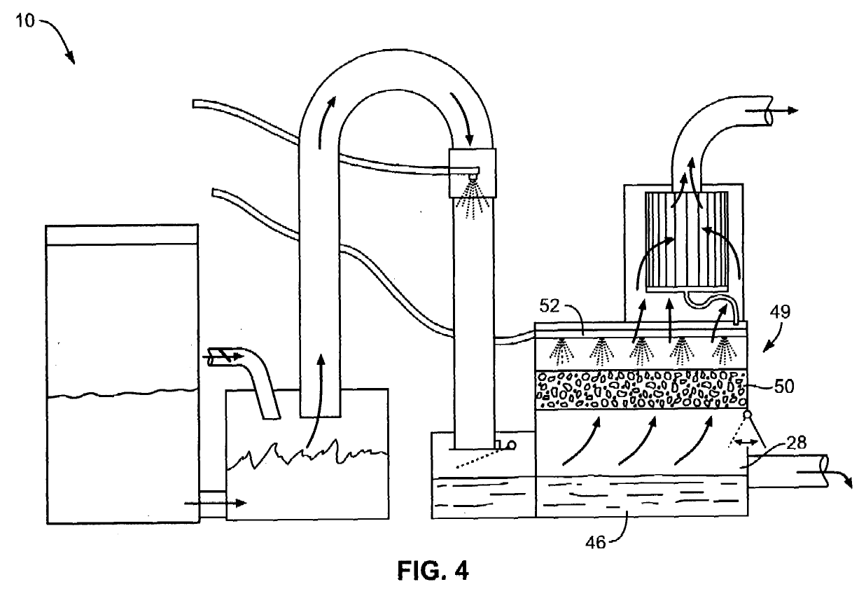

Referring to FIG. 4, in certain embodiments, a chamber 28 may include a scrubber 49 to remove residual sulfur dioxide gas from the exhaust prior to entering the recovery system 32. As illustrated, the scrubber 49 is inside the chamber 28. However, in other embodiments, a scrubber 49 may be provided in a tower or other structure connected to the chamber 28 and coupled to the recovery system 32. In other embodiments, the scrubber 49 may be used without a recovery system 32 and may be mounted on the chamber 28.

For example, a scrubber 49 may include scrubber packing 50, such as cut-up PVC pipe, and one or more water sprayers 52 or outlets 52 to provide a water counter-flow through the scrubber packing 50. The scrubber packing 50 may create a tortuous path for the water, thereby increasing the surface area of the water as well as both turns and path length of the exhaust flow and the resulting contact between the exhaust and the water. After flowing through the scrubber packing 50, the water and any sulfur dioxide captured thereby may flow into the primary supply of sulfurous acid 46. The remaining exhaust may flow through the recovery system 32 to separate the mist from the exhaust, remove residual sulfur dioxide gas from the exhaust, and provide a pressure differential.

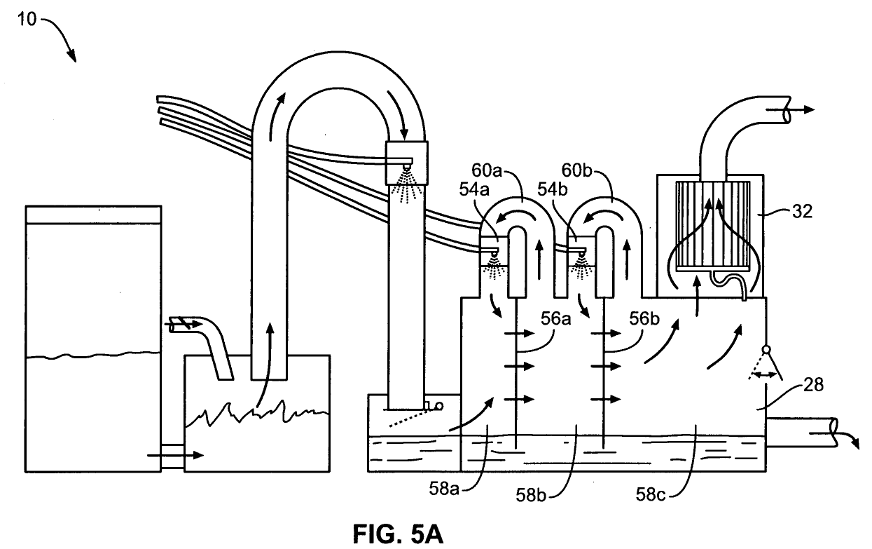

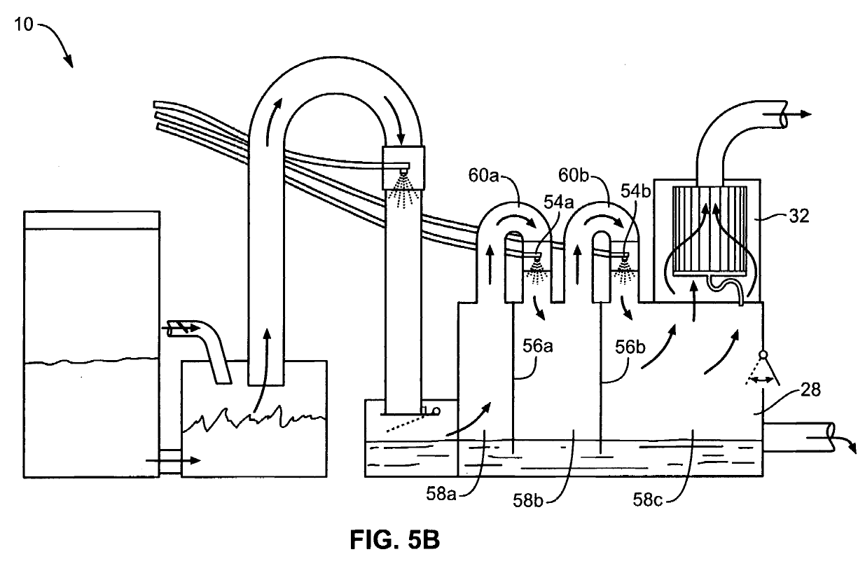

Referring to FIG. 5A, in another embodiment, the chamber 28 may include one or more additional eductors 54a, 54b to remove additional sulfur dioxide gas from the exhaust. For example, in one embodiment, upon entering the chamber 28, the exhaust may flow through one or more perforated baffles 56a, 56b or other obstructions 56a, 56b. These baffles 56a, 56b may allow sulfurous acid to flow beneath the baffles 56a, 56b, but may slow or restrict the flow of exhaust through the baffles 56a, 56b. In effect, the baffles 56a, 56b may divide the chamber into multiple sub-chambers 58a, 58b, 58c. The apertures in the baffles 56a, 56b may be sized to circulate and slow the net speed flow of exhaust, while allowing sufficiently high volumetric flow rates to maintain high burn rates in the sulfur burner 14.

In certain embodiments, one or more eductors 54a, 54b may remove residual sulfur dioxide gas from the exhaust by circulating the exhaust between the chambers 58a, 58b, 58c. For example, a first eductor 54a may draw in, through a channel 60a, exhaust from the chamber 58b and re-circulate it to the chamber 58a. Meanwhile, the eductor 54a may remove residual sulfur dioxide gas from the exhaust by mixing the exhaust with water. Similarly, a second eductor 54b may draw in, through a channel 60b, exhaust from the chamber 58c and re-circulate it to the chamber 58b. This eductor 54b may also remove residual sulfur dioxide gas from the exhaust by mixing water with the exhaust. Each time the exhaust is drawn in by an eductor 54a, 54b, additional sulfur dioxide may be removed from the exhaust. Ultimately, the exhaust may be drawn through the recovery system 32 to separate mist from the exhaust, remove residual sulfur dioxide gas, provide a pressure differential, or a combination thereof.

Referring to FIG. 5B, in another embodiment, the chamber 28 may include one or more solid (i.e., non-perforated) baffles 56a, 56b creating sub-chambers 58a, 58b, 58c. One or more eductors 54a, 54b may be used to draw in exhaust from the chambers 58a, 58b to remove additional sulfur dioxide gas from the exhaust. Because the baffles 56a, 56b are solid and may extend into the sulfurous acid supply, this may prevent the exhaust from flowing beneath the baffles 56a, 56b. This, in turn, forces the exhaust through the channels 60a, 60b and the eductors 54a, 56b.

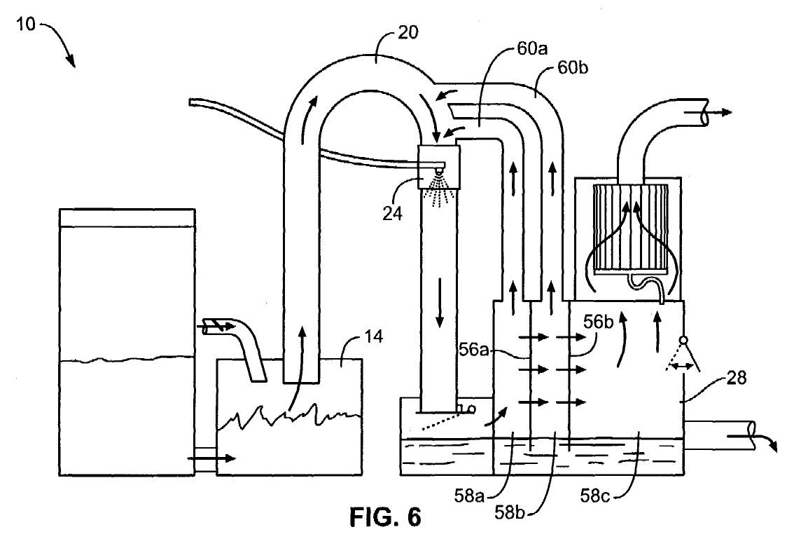

Referring to FIG. 6, in other embodiments, exhaust may be drawn from the chambers 58a, 58b through the primary eductor 24. In this embodiment, a single high-volume eductor 24 may be used not only to draw in gases from the sulfur burner 14 but also to remove residual sulfur dioxide gas from the exhaust in the chamber 28. This may simplify the design by eliminating or reducing the need for additional eductors 54a, 54b and, consequently, eliminating or reducing the need for additional water. Like the previous example illustrated in FIG. 5, in certain embodiments, one or more baffles 56a, 56b may slow or restrict the flow speed of exhaust through the baffles 56a, 56b, creating multiple sub-chambers 58a, 58b, 58c. Channels 60a, 60b may be used to draw in exhaust from the sub-chambers 58a, 58b, into the induction channel 20, where it may be drawn in by the eductor 24.

Because feeding the channels 60a, 60b into the induction channel 20 may ultimately reduce the suction in the induction channel 20, the eductor 24 may be sized to provide sufficient air flow through the sulfur burner 14 in addition to handling the additional channels 60a, 60b. In certain embodiments, the channels 60a, 60b may be significantly narrower than the induction channel 20 such that air flow through the sulfur burner 14 is not negatively effected.

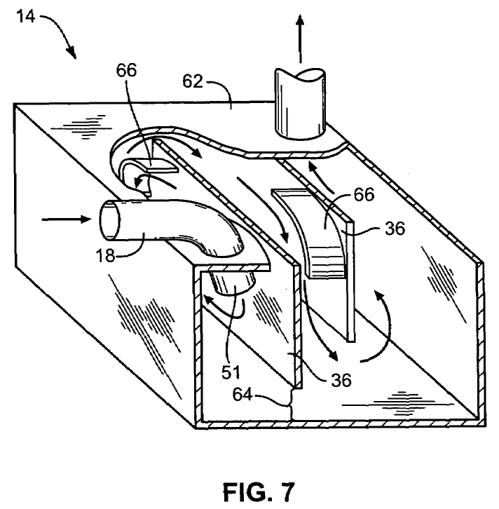

Referring to FIG. 7, as previously mentioned, in certain embodiments, a sulfur burner 14 in accordance with the invention may include a series of baffles 36 arranged in a serpentine or other tortuous pattern to circulate air over the burning sulfur. In certain embodiments, this may increase burn rate capacities without increasing the overall size or height of the burner 14. The baffles 36 may also provide significantly larger sulfur consumption rates without significantly increasing the air flow intake through the inlet 18. This increase in efficiency is believed to be the result of the additional contact time between the oxygen and the burning sulfur as it circulates around the baffles 36. This may also reduce oxygen levels in gases exiting the burner 14.

The baffles 36 may extend from the top of the burner 14 and may reside above the bottom of the burner a specified distance 64, such as several inches, to provide a clear path for sulfur to enter the burner 14. In certain embodiments, a lid 62 may provide the top 62 of the burner 14. In such embodiments, the baffles 36 may be attached directly to the lid 62. In selected embodiments, one or more deflectors 66 may also be used to further circulate the air flow vertically and horizontally in the burner 14. These deflectors 66 may increase the contact and dwell time between the oxygen and the burning sulfur and lengthen the path that air must take to enter and exit the burner 14. The deflectors 66 may provide a quarter-turn (as illustrated), a half-turn, or the like, as desired, to provide additional circulation within the burner 14. Similarly, the deflectors 66 may be attached to the baffles 36, the top 62 of the burner 14, or to a lid 62 where provided.

Referring to FIG. 8, in certain embodiments, the air inlet 18 may also include a backflow inhibitor 42. The backflow inhibitor 42 may allow air to enter the inlet 18 in one direction 72 but may prevent air flow in the opposite direction. In one embodiment, the valve 42 may seal against an inlet tube 74 when the air flows opposite the direction 72.

The backflow inhibitor 42 may serve several purposes. First, the backflow inhibitor 42 may prevent sulfur from exiting the inlet 18 in the event of an overflow condition. Second, the backflow inhibitor 42 may prevent exhaust or other gases from exiting the inlet 18 in the event the air or exhaust flow is reversed. For example, even when the air inlet 18 is shut, the burner 14 may still be open to atmosphere by way of backflow through the downstream ducting (e.g., the induction channel 20, etc.). This may lead to a prolonged, tapered, slow burn as the sulfurous acid generator 10 slowly cools and the flame extinguishes.

Furthermore, with the water turned off, there is no longer any method for capturing the sulfur dioxide gas which is then left to escape to the atmosphere. As previously mentioned, this condition can and has led to fires caused by unburned molten sulfur overflowing out of the air inlet 18. The backflow inhibitor 42 may be used to seal the burner 14 to any access to atmosphere or to the flow of exhaust through the inlet 18 when the generator 10 is in a shut down mode or in the event of an unexpected interruption of the water flow. In other embodiments, the backflow inhibitor 42 may be connected to operate in response to a bladder or float that shuts the inlet 18 when the water supply to the generator as been interrupted or shut off.

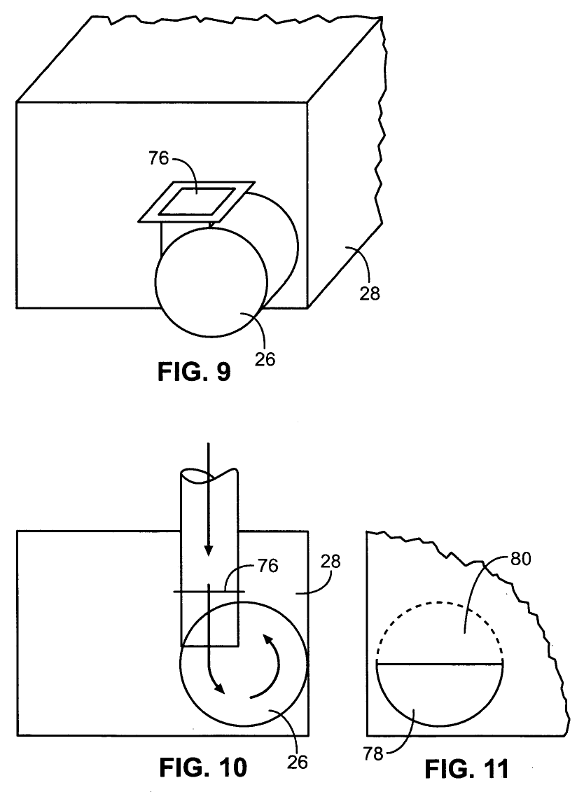

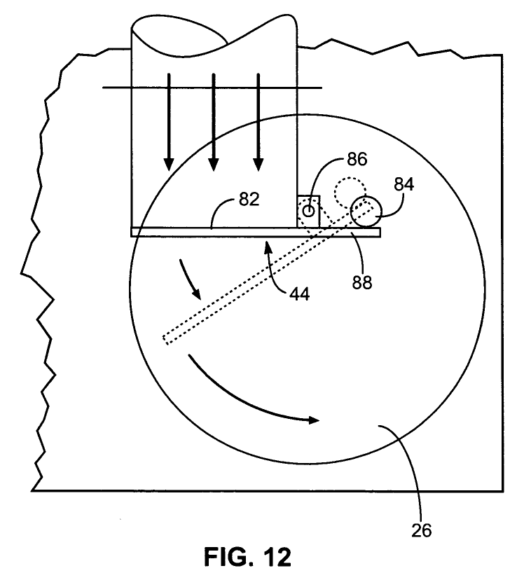

Referring to FIGS. 9 through 11, as previously mentioned, a cyclone mixer 26 may be coupled to the chamber 28. The cyclone mixer 26 may receive sulfurous acid and any residual water and gases from the induction channel 20. The induction channel 20 may direct these liquids and gases into a port 76 of the cyclone mixer 26. Upon entering, these liquids and gases may be swirled or circulated around cyclone mixer 26 to provide additional mixing and agitation. These liquids and gases may then enter the chamber 28. In certain embodiments, a passageway 78 connecting the cyclone mixer 26 to the chamber 28 may be provided only along the lower half or other portion of the cyclone mixer 26. An upper blocked portion 80 may be used to briefly retain liquids and gases within the cyclone mixer 26 once they enter from the induction channel 20. Once mixed, these liquids and gases may then flow into the chamber 28 through the passageway 78.

Referring to FIG. 12, in certain embodiments, a safety valve 44 may be provided at or near the bottom of the induction channel 20 where it enters the cyclone mixer 26. In one embodiment, the safety valve 44 may include a valve door 82, a counterweight 84, and a pivot 86. The counterweight 84 may be sized to keep the valve door 82 in an upward (or closed) position when the water supply (supplied through the eductor 24) is turned off. However, when the water supply is turned on, the force and momentum of water opens the safety valve 44 (as represented by the dotted lines) as it travels downward through the induction channel 20.

One of ordinary skill in the art will recognize that the size of counterweight 84 may be varied simply by adjusting the length of the moment arm 88 relative to the pivot 86. In certain embodiments, the counterweight may be adjustable along the moment arm 88. Furthermore, the counterweight 84 may be located above or below the moment arm 88. In certain embodiments, the counterweight 84 may include a tube with a cap. This may allow different weights to be inserted into the tube to adjust the weight of the counterweight 84.

Like the backflow inhibitor 42 described in association with FIG. 8, the safety valve 44 may resist, prevent, or reduce backflow through the downstream ducting (e.g., the induction channel 20, etc.), which would otherwise allow combustion to continue in the burner 14 after the generator 10 has been shut down or the water supply to the eductor 24 has been interrupted.

Referring to FIG. 13, in certain embodiments, the moment arm 88 may be non-parallel with respect to the valve door 82. This may reduce interference between the counterweight 84 and the mixer 26 when the valve door 82 opens. This may also allow the valve door 82 to open further before the counterweight 84 comes into contact with the mixer 26.

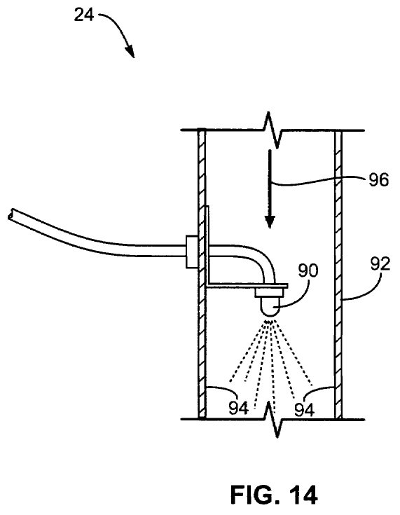

Although the safety valve 44 employs a counterweight 84 as the biasing mechanism, in other embodiments the safety valve 44 may employ other biasing mechanisms, such as a spring, elastomeric material, pneumatic or hydraulic cylinder, bladder, float device, or the like, to keep the valve 44 closed in the event the water flow through the eductor 24 is interrupted. For example, a bladder or float may be connected to require a certain water level in the chamber 28 before permitting the valve 44 to open. Thus, the valve 44 illustrated in FIGS. 12 and 14 represents only one contemplated embodiment of a safety valve 44 in accordance with the invention.

Referring to FIG. 14, in one embodiment, an improved eductor 24 in accordance with the invention may include a centrally or substantially centrally located nozzle 90, or atomizer 90. The nozzle 90 may emit a high pressure or high velocity stream of water such as a spray, either pre-filtered or not, through a throat 92. This spray creates a momentum transfer to the surrounding gas, drawing gases 96 into the spray. In certain embodiments, the spray may intercept the sidewalls 94 of the eductor 24 and cause the gas 96 to meet the liquid at or near the sidewalls 94. At the sidewalls 94, the gas 96 may be subject to drag forces which maximize its absorption into the water. In selected embodiments, the nozzle 90 may emit a conical spray to effectively and evenly contact the sidewalls 94.

An eductor 24 employing the above-described design may utilize considerably lower water flows than conventional eductors, while still drawing sufficient amounts of sulfur dioxide gas into the induction channel 20. Because the improved eductor 24 uses far less water, any “extra” water available may be used for other purposes, such as driving additional eductors, or the reduced water flow may be useful in low flow situations, such as drip irrigation applications. In certain embodiments, two or more eductors 24 may be attached in series, parallel, or combinations thereof, to draw in either the same or increased amounts of sulfur dioxide gas using far less water. Such arrangements may also allow for multiple water scrubbings of sulfur dioxide gas that was not already absorbed. Such an arrangement may also minimize or reduce the amount of sulfurous acid mist formed.

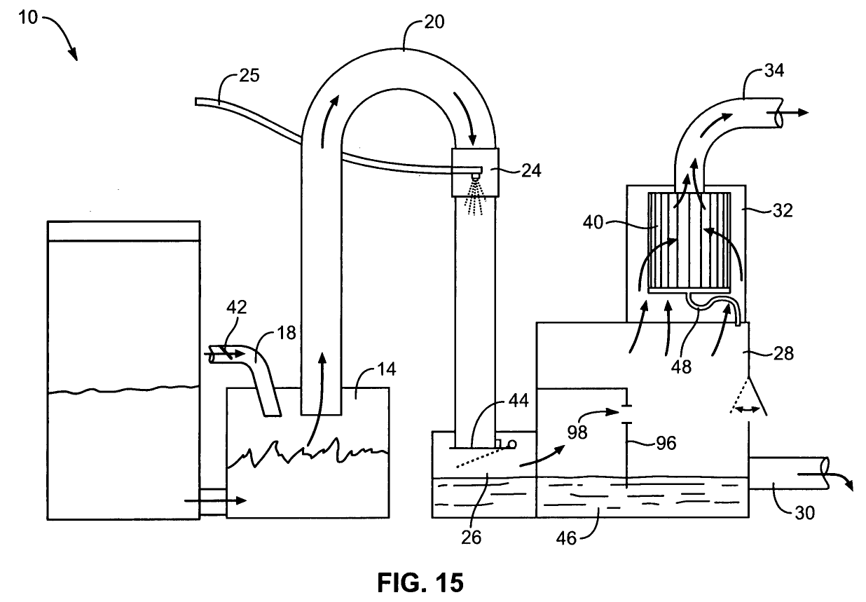

Referring to FIG. 15, in certain embodiments, a baffle 96 or partition 96 may be provided within the chamber 28. The baffle 96 or partition 96 may extend downward into the liquid sulfurous acid to provide a water seal preventing exhaust gases from passing beneath the baffle 96. Exhaust may be routed tortuously through one or more openings 98 in the baffle 96 or partition 96 to separate larger liquid droplets or mist from the exhaust prior to routing through the recovery system 32. That is, by routing the exhaust through the one or more openings 98, many suspended droplets or larger mist particles may impact the sidewalls of the partition 96, combine, and flow down the sidewalls into the primary supply of sulfurous acid 46. Thus, a simple baffle 96 or partition may effectively separate many droplets from the exhaust flow prior to entering the recovery system 32. In other contemplated embodiments, exhaust may be routed through the opening 98 to one or more secondary eductors (not shown) to remove additional sulfur dioxide gas from the exhaust.

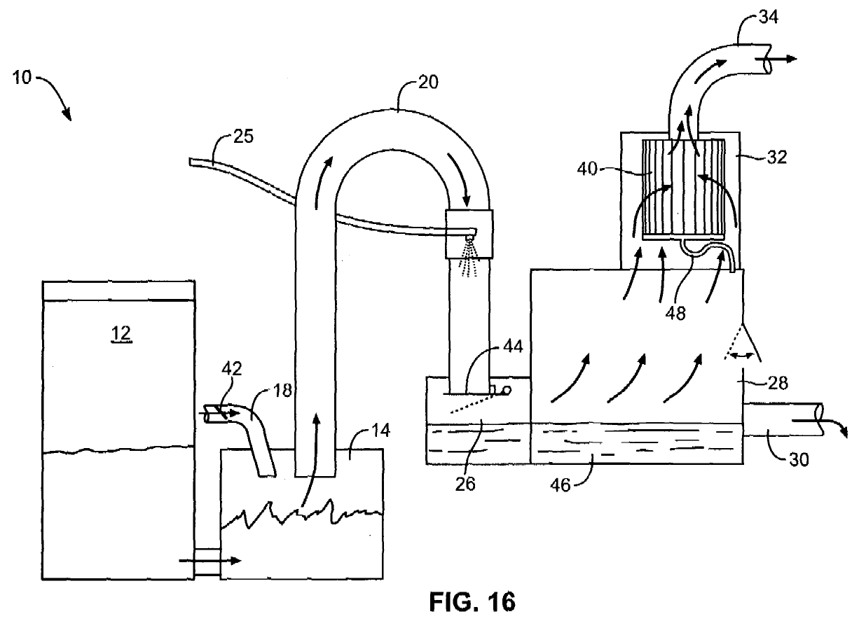

Referring to FIG. 16, in certain embodiments, the hopper 12, burner 14, and chamber 28 may be mounted to a single base 38. That is, in certain embodiments, a chamber 28 may be mounted adjacent to and on the same base 38 as a sulfur burner 14. One disadvantage or drawback of a chamber 28 employing a gravity discharge is that it may only have sufficient head (pressure) to discharge into a lagoon below it and, therefore, relatively close (e.g., 30 feet or less) to the water being treated. The lagoon would normally be at a lower elevation than the chamber 28 since siphoning is not generally reliable. A chamber 28 employing a gravity discharge may be severely limited in its ability to deploy across various irrigation systems. For example, gravity discharge may be unsuitable to service irrigation systems over hilly terrain or which are under pressure or do not have lagoons. This may include numerous irrigation systems used in agriculture, water treatment, industry, mining, and other applications.

In alternative embodiments in accordance with the invention, a chamber 28 may be mounted at a higher level than a burner 14 or other components of a sulfurous acid generator 10, as illustrated in FIG. 16. This may allow the chamber 28, and gravity discharge, to be mounted higher than the burner 14, or other components, on either the same or a separate base 38. This may also allow the chamber 28 to be mounted high enough to develop the necessary pressure head for discharge into a lagoon located at various elevations and at various distances, without requiring elevation of the burner 14, hopper 12, or other components of the sulfurous acid generator 10. This also has the advantage of making it easier to load the hopper 12 (e.g., at ground level) and avoids placing the burner 14 at a higher elevation, where it may create a safety risk. In certain embodiments, the generator 10 may also employ additional eductors, venturis, aspirators, siphons, or the like, after the outlet 30 of the chamber 28. Thus, the sulfurous acid stream may be reintegrated into a pressurized irrigation line.

Where the chamber 28 is mounted at a different level than the burner 14, the induction channel 20 may require appropriate modification (e.g., lengthening, bending, etc.) to connect the chamber 28 and burner 14 together. In certain embodiments, a flexible induction channel 20, such as a section of diametrally stiff flexible hose or tubing, may be used as the induction channel 20.

The present invention may be embodied in other specific forms without departing from its basic features or essential characteristics. The described embodiments are to be considered in all respects only as illustrative, and not restrictive. The scope of the invention is, therefore, indicated by the appended claims, rather than by the foregoing description. All changes within the meaning and range of equivalency of the claims are to be embraced within their scope.

What is claimed is:

1. A system to retrieve a mist of sulfurous acid and create sulfurous acid from residual sulfur dioxide gas originating from an exhaust of a sulfurous acid generator, the system comprising:
a sulfurous acid generator to output sulfurous acid, in a primary stream, and exhaust comprising a mist of sulfurous acid and sulfur dioxide gas;
a recovery system connected to the sulfurous acid generator to receive the exhaust, substantially remove the mist, and remove the sulfur dioxide gas;
the recovery system, further structured to pass the exhaust to apertures therein sized to separate the mist from the exhaust, wet itself with the liquid of the mist, and capture the sulfur dioxide gas with the liquid to substantially remove them both from the exhaust; and
a path from the recovery system to conduct a recovered stream of sulfurous acid generated by the recovery system.

2. The system of claim 1, wherein the recovery system comprises a filter selected from the group consisting of a fiber bed, a filament bundle, a screen, a sieve, a mesh, a paper, a natural textile fabric, a synthetic polymer fabric, a metal fabric, a woven fabric, a non-woven fabric, a media filter, and a combination of two or more thereof.

3. The system of claim 2, wherein the filter comprises a plurality of layers.

4. The system of claim 1, wherein the apertures are sized to separate mist particles having a size of less than 30 microns.

5. The system of claim 1, wherein the recovery system contacts the mist through at least one of inertial impaction, interception, and Brownian diffusion.

6. The system of claim 1, wherein the path directs the recovered stream into the primary stream of sulfurous acid.

7. The system of claim 1, further comprising an outlet coupled to the recovery system and a motive source to at least one of draw and push the exhaust through the recovery system.

8. The system of claim 7, wherein the motive source comprises at least one of a fan, a venturi, an aspirator, and an eductor.

9. The system of claim 1, wherein the sulfurous acid generator comprises a sulfur dioxide gas scrubber prior to the recovery system.

10. The system of claim 1, wherein the recovery system is one of integrated with the sulfurous acid generator and “stand alone” relative to the sulfurous acid generator.

1 1. The system of claim 2, wherein the apertures are sized to separate mist particles having a size of less than 30 microns.

12. The system of claim 11, wherein the recovery system contacts the mist through at least one of inertial impaction, interception, and Brownian diffusion.

13. The system of claim 12, wherein the path directs the recovered stream into the primary stream of sulfurous acid.

14. The system of claim 13, further comprising an outlet coupled to the recovery system and a motive source to at least one of draw and push the exhaust through the recovery system.

15. A method to retrieve a mist of sulfurous acid and create sulfurous acid from residual sulfur dioxide gas originating from an exhaust of a sulfurous acid generator, the method comprising:
generating sulfurous acid, in a primary stream, and exhaust comprising a mist of sulfurous acid and sulfur dioxide gas;
receiving the exhaust and substantially removing the mist and residual sulfur dioxide gas;
passing the exhaust through apertures sized to separate the mist from the exhaust, wetting the apertures with the liquid of the mist, and capturing the sulfur dioxide gas with the liquid to substantially remove them both from the exhaust; and
providing a recovered stream of sulfurous acid.

16. The method of claim 15, wherein passing the exhaust through apertures comprises passing the exhaust through a filter selected from the group consisting of a fiber bed, a filament bundle, a screen, a sieve, a mesh, a paper, a natural textile fabric, a synthetic polymer fabric, a metal fabric, a woven fabric, a non-woven fabric, a media filter, and a combination of two or more thereof.

17. The method of claim 15, wherein passing the exhaust through apertures comprises passing the exhaust through apertures sized to separate mist particles having a size of less than 30 microns from the exhaust.

18. The method of claim 15, wherein separating the mist from the exhaust comprises contacting the mist through at least one of inertial impaction, interception, and Brownian diffusion.

19. The method of claim 15, further comprising directing the recovered stream into the primary stream of sulfurous acid.

20. A system to retrieve a mist of sulfurous acid and create sulfurous acid from residual sulfur dioxide gas originating from an exhaust of a sulfurous acid generator, the system comprising:
a sulfurous acid generator comprising a source of sulfur dioxide and a source of water connected to feed into a mixer to output sulfurous acid, in a primary stream, and exhaust comprising a mist of sulfurous acid, water vapor, nitrogen gas, and sulfur dioxide gas;
a recovery system connected to the sulfurous acid generator to receive the exhaust and substantially remove the mist and the sulfur dioxide gas;
the recovery system, further structured to pass the exhaust to apertures therein sized to separate the mist from the gases, wet itself with the liquid of the mist, and capture the sulfur dioxide gas with the liquid to substantially remove them both from the exhaust; and
a path from the recovery system to conduct a recovered stream of sulfurous acid generated by the recovery system.
